(19) United States
(12) Patent Application Publication
(10) Pub. No.: US 2011/0007712 A1
(43) Pub. Date: Jan. 13, 2011

(54) METHODS AND SYSTEMS FOR EFFECTIVE HANDOVER BETWEEN BASE STATIONS

(75) Inventor: Chun Woo Lee, Santa Clara, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/501,551

(22) Filed: Jul. 13, 2009

(51) Int. Cl. H04W 36/00

(52) U.S. Cl. 370/332; 455/437

(57) ABSTRACT

This application includes signaling techniques for performing scanning and handover of a mobile station between a base station and a Femto base station in a wireless communication system.

### TECHNICAL FIELD

Certain embodiments of the present disclosure generally relate to wireless communication and, more particularly, to an effective handover mechanism between a Femto base station and another base station.

### SUMMARY

Certain embodiments provide a method for wireless communications by a Femto base station (FBS). The method generally includes monitoring signal quality of a mobile station and transmitting a request for a handover from a serving base station to the Femto base station if the signal quality is higher than a threshold, and initiating handover of the mobile station from the serving base station to the FBS.

Certain embodiments provide a method for wireless communications by a mobile station (MS). The method generally includes transmitting a signal to a serving base station (BS), receiving, from the serving BS, information about a Femto BS that is a candidate for handover, and performing scanning based on the information received about the FBS.

Certain embodiments provide a method for wireless communications by a serving Base Station (BS). The method generally includes transmitting channel description and MAP messages to at least one Femto base station (FBS) through a back-bone network, receiving a request for handover from the FBS, transmitting a signal to a mobile station (MS) with information about the FBS, and receiving a message from the MS to initiate the handover from the serving base station to the FBS.

Certain embodiments of the present disclosure provide an apparatus for wireless communications by a Femto base station (FBS). The apparatus generally includes logic for monitoring signal quality of a mobile station, logic for transmitting a request for a handover from a serving base station to the Femto base station if the signal quality is higher than a threshold, and logic for initiating handover of the mobile station from the serving base station to the FBS.

Certain embodiments of the present disclosure provide an apparatus for wireless communications by a mobile station (MS). The apparatus generally includes logic for transmitting a signal to a serving base station (BS), logic for receiving, from the serving BS, information about a Femto BS that is a candidate for handover, and logic for performing scanning based on the information received about the FBS.

Certain embodiments of the present disclosure provide an apparatus for wireless communications by a serving Base Station (BS). The apparatus generally includes logic for receiving a request for handover from a Femto base station (FBS), logic for transmitting a signal to a mobile station (MS) with information about the FBS, and logic for receiving a message from the MS to initiate the handover from the serving base station to the FBS.

Certain embodiments of the present disclosure provide an apparatus for wireless communications by a Femto base station (FBS). The apparatus generally includes means for monitoring signal quality of a mobile station, means for transmitting a request for a handover from a serving base station to the Femto base station if the signal quality is higher than a threshold, and means for initiating handover of the mobile station from the serving base station to the FBS.

Certain embodiments of the present disclosure provide an apparatus for wireless communications by a mobile station (MS). The apparatus generally includes means for transmitting a signal to a serving base station (BS), means for receiving, from the serving BS, information about a Femto BS that is a candidate for handover, and means for performing scanning based on the information received about the FBS.

Certain embodiments of the present disclosure provide an apparatus for wireless communications by a serving Base Station (BS). The apparatus generally includes means for receiving a request for handover from a Femto base station (FBS), means for transmitting a signal to a mobile station (MS) with information about the FBS, and means for receiving a message from the MS to initiate the handover from the serving base station to the FBS.

Certain embodiments of the present disclosure provide a computer-program product for wireless communications by a Femto base station (FBS), comprising a computer readable medium having instructions stored thereon, the instructions being executable by one or more processors. The instructions generally include instructions for monitoring signal quality of a mobile station, instructions for transmitting a request for a handover from a serving base station to the Femto base station if the signal quality is higher than a threshold, and instructions for initiating handover of the mobile station from the serving base station to the FBS.

Certain embodiments of the present disclosure provide a computer-program product for wireless communications by a mobile station (MS), comprising a computer readable medium having instructions stored thereon, the instructions being executable by one or more processors. The instructions generally include instructions for transmitting a signal to a serving base station (BS), instructions for receiving, from the serving BS, information about a Femto BS that is a candidate for handover, and instructions for performing scanning based on the information received about the FBS.

Certain embodiments of the present disclosure provide a computer-program product for wireless communications by a serving Base Station (BS), comprising a computer readable medium having instructions stored thereon, the instructions being executable by one or more processors. The instructions generally include instructions for receiving a request for handover from a Femto base station (FBS), instructions for transmitting a signal to a mobile station (MS) with information about the FBS, and instructions for receiving a message from the MS to initiate the handover from the serving base station to the FBS.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates a regular hand-over procedure between a mobile station (MS), a serving base station (BS) and a target BS utilizing Mobile Worldwide Interoperability for Microwave Access (WiMAX) technology.

FIG. 5 illustrates an example wireless network including a BS, a Femto base station (FBS) and an MS in accordance with certain embodiments of the present disclosure.

FIG. 6 illustrates example operations for an effective handover between a serving BS and a Femto BS in accordance with certain embodiments of the present disclosure.

FIG. 6A illustrates example components capable of performing the operations illustrated in FIG. 6.

FIG. 7 illustrates an example handover from a serving BS to an FBS in accordance with certain embodiment of the present disclosure.

FIG. 8 illustrates a second example operations for an effective handover between a serving BS and a Femto BS in accordance with certain embodiments of the present disclosure.

FIG. 8A illustrates example components capable of performing the operations illustrated in FIG. 8.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A Femto base station (FBS) is a device that may be used to improve either mobile network coverage in small areas or network capacity in crowded areas. Femto base stations may connect locally to the mobile phones and similar devices through their existing radio connections supported by Global System for Mobile communications (GSM), Code Division Multiple Access (CDMA), Universal Mobile Telecommunications System (UMTS), Long Term Evolution (LTE) or Worldwide Interoperability for Microwave Access (WiMAX) standards. Femto base stations may route the received information through a broadband internet connection back to the carrier, bypassing the normal cell towers that are arrayed across the area.

A regular base station (BS), utilizing the Institute of Electrical and Electronics Engineers (IEEE) 802.16 standard, broadcasts a mobility neighborhood

advertisement MOB_NBR-ADV message that contains information about all the neighboring base stations. The mobile stations in the network may scan those base stations to look for handover candidates when the channel quality between the MS and the serving BS drops under a certain threshold.

The number of Femto base stations in a network may be much larger than the number of base stations. Therefore, it may not be feasible for a serving BS to include information about all the Femto base stations into the MOB_NBR-ADV message, since it will increase the message size significantly. Assuming that there are many FBSs that have different center frequencies and radio frequency (RF) bandwidths, an MS may not be able to scan all the possible FBSs before losing the signal from the serving BS.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

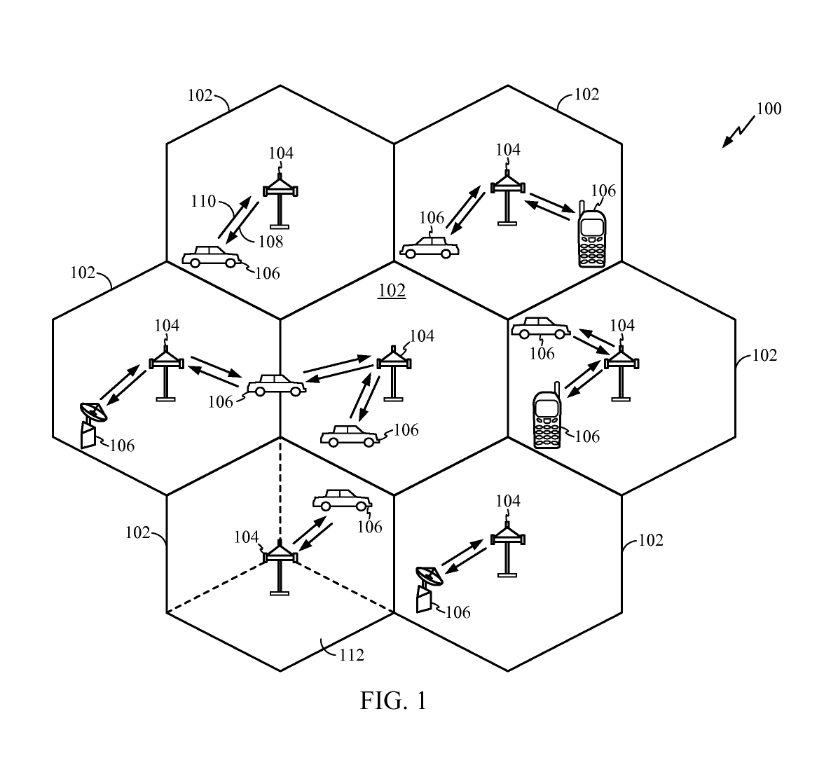

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

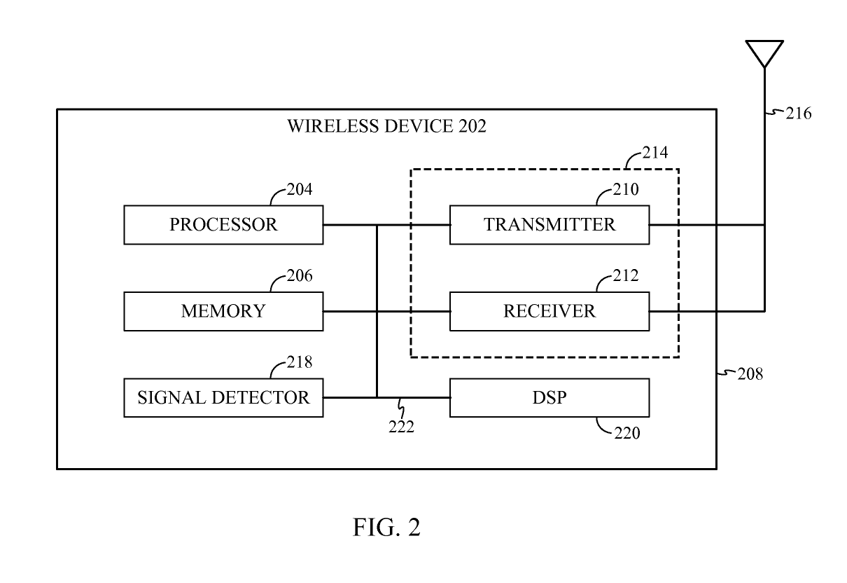

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

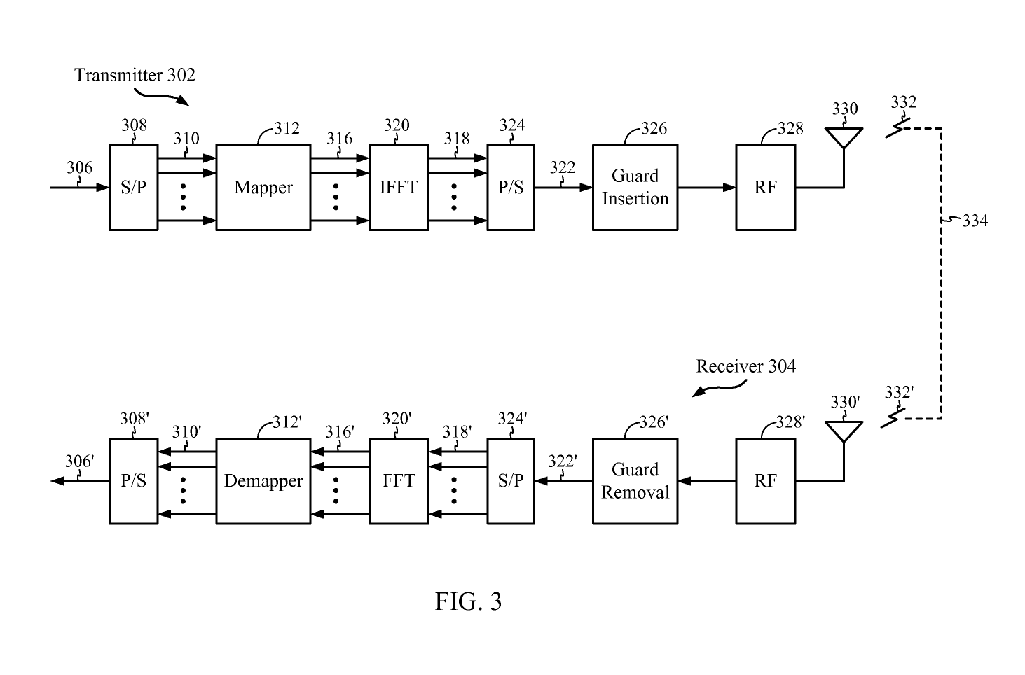

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp}, (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

Exemplary Effective Handover Mechanism between a Femto Base Station and a Non-Femto Base Station

When channel conditions between a mobile station (MS) and the serving base station (BS) deteriorate, the MS may need to handover to a different BS with better channel conditions. Handover provides a continuous connection when a Mobile Station (MS) migrates from an air-interface of one BS to another air-interface provided by another BS.

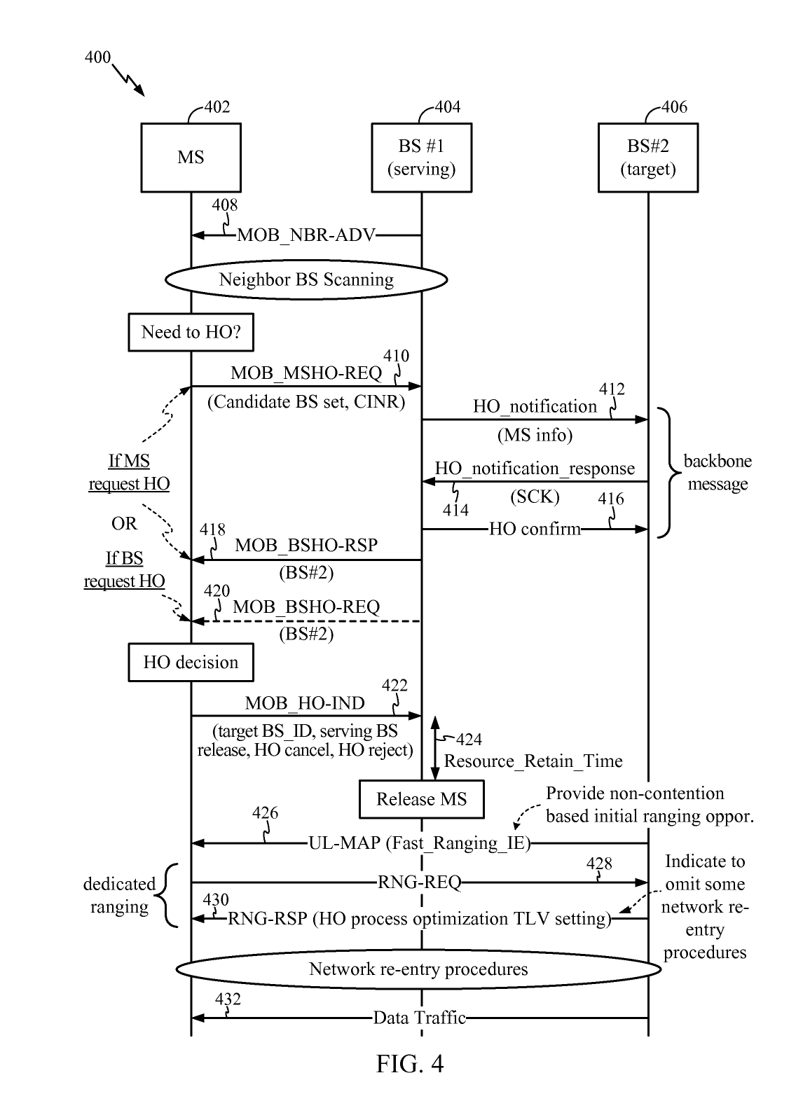

FIG. 4 illustrates normal handover procedure in the mobile WiMAX standard. As illustrated, the serving BS 404 may send a Mobility Neighborhood Advertisement (MOB_NBR-ADV) message 408 to all the mobile stations in its vicinity. The MOB_NBR-ADV message includes information about the neighboring base stations. An MS 402 may initiate a handover by sending a request to the serving BS through a Mobile Handover Request (MOB_MSHO-REQ) message 410. The MOB_MSHO-REQ message may include a target BS 406 and its corresponding carrier to noise plus interference ratio (CINR) information.

Next, the serving BS may send a Handover Notification (HO_notification) message 412 that may include information about the MS to the target BS 406. The target BS may send a Handover Notification Response (HO_notification_response) message 414 to the serving base station 404 to acknowledge the handover. The serving BS may confirm 416 the handover by sending a Base Station Handover Response (MOB_BSHO-RSP) message 418 to the MS. Therefore, the serving BS may finalize the handover of the MS to the target BS 406.

Under certain conditions, a serving BS 404 may initiate a handover by sending a request to the MS 402 through a Base Station Handover Request (MOB_BSHO-REQ) message 420. The MS 402 may agree with the handover by sending a Mobility Base Station Hand Over Indication (MOB_BSHO-IND) message 422 to the serving BS 404. This message may include a target base station identifier (BS_ID), serving BS release, handover cancellation (HO_cancel) and handover rejection (HO_reject) information. After a certain amount of time, equal to the Resource-Retain_Time 424, is passed, the serving BS 404 may release the MS. Next, the target BS 406 may send the UL-MAP (Fast_Ranging_IE) message 426 to the MS 402 to provide a non-contention-based initial ranging opportunity for the MS.

The MS may perform dedicated ranging by transmitting a Raging Request (RNG-REQ) message 428 to the target base station 406. The target BS may send a Ranging Response (RNG-RSP) message 430 that may include information for handover process optimization. Next, the MS 402 may perform network re-entry procedures with the target BS 406 and data traffic 432 may follow.

In WiMAX uplink, before an MS is allowed to send data or signal to the serving BS, the MS must have valid UCD (Uplink Channel Description) and UL-MAP(Uplink Access Definition) messages. A serving BS in WiMAX standard may transmit a UCD message occasionally. The UCD message may include information about uplink channel configuration such as uplink burst profile, initial ranging code range and the permutation base. The MS may not transmit anything before it receives a UCD message from the serving BS.

In addition, a serving BS may broadcast a UL-MAP message that describes uplink sub-frame structure for each frame. An MS may transmit data or signal if the UL-MAP includes IE (Information Element) that specifies UL resources for the MS. Typically, a BS specifies an MS by Basic CID (Connection Identification) which may be a unique value in the network

The Institute of Electrical and Electronics Engineers (IEEE) 802.16 standard introduces a CQICH_Alloc_IE message to dynamically allocate or de-allocate a CQICH (Channel Quality Information Channel) to a mobile station. Once allocated, the MS may transmit channel quality information on the assigned CQICH channel on the subsequent frames until the MS receives a CQICH_Alloc_IE message to de-allocate the assigned CQICH channel. A CQICH_ID message is a component of the CQICH_Alloc_IE message, which may be a unique value in the network as long as the CQICH channel allocation is valid. A CQICH region may be described by another information element (IE) that is called Fast-Feedback_IE. Both Fast-Feedback_IE and CQICH_Alloc_IE messages may be delivered through the UL-MAP message.

As described above, a Femto base station (FBS) is a device that may be used to improve either mobile network coverage in small areas or network capacity in crowded areas. Femto cells connect locally to the mobile phones and similar devices through their existing radio connections supported by Global System for Mobile communications (GSM), Code Division Multiple Access (CDMA), Universal Mobile Telecommunications System (UMTS), Long Term Evolution (LTE) or Worldwide Interoperability for Microwave Access (WiMAX) standards. Femto cells may route the received information through a broadband internet connection back to the carrier, bypassing the normal cell towers that are arrayed across the area.

According to the IEEE 802.16 standard, a base station (BS) broadcasts the MOB_NBR-ADV message to the mobile stations regularly. The MOB_NBR-ADV may contain information about all the neighboring base stations so that mobile stations in the network can scan those BSs when the channel quality between the MS and the serving BS drops under a certain threshold.

The number of Femto base stations in the network may be much larger than number of base stations. Therefore, it may not be feasible for the serving BS to include information about all the Femto base stations into the MOB_NBR-ADV message, since including this information may increase the message size significantly. Because Femto base stations may have different center frequencies and RF bandwidths, an MS may not be able to scan all the possible FBSs before it loses the signal from the serving BS.

Therefore, the present disclosure may propose a technique to scan the channel and handover from a serving BS to an FBS to reduce the total handover lead time between an MS, the serving BS and the FBS. According to certain embodiments of the present disclosure, the FBS may scan the mobile stations that have entered their coverage, in contrast with MSs scanning the BSs in cellular mobile networks.

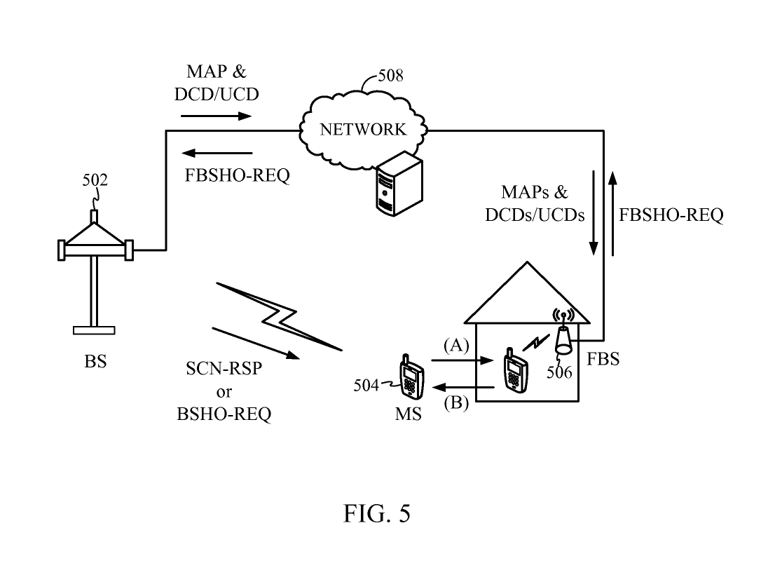

FIG. 5 illustrates a mobile network including an MS 504, a serving BS 502 and an FBS 506. The MS 504 may communicate with the serving BS 502 through the air. When the MS goes inside a building and gets close to the FBS, it may want to perform a handover to the FBS 506 that may be connected to the serving BS 502 through the backbone network 508. The Femto base station may use a frequency and an RF bandwidth that are different from the ones used by the serving BS 502. Therefore, it may not be feasible for the MS to scan many potential FBSs.

For certain embodiments of the present disclosure, the FBS may perform scanning instead of the MS. Two example scenarios are presented for a handover from the serving BS to the FBS. In both of these example scenarios, an FBS may perform scanning to find potential MSs for handover.

In the first example scenario, an FBS may monitor uplink signals of the mobile stations to find a set of candidates for handover according to certain embodiments of the present disclosure. This example scenario may not require any special feature for the MS. Therefore, this scenario may be employed by any of the mobile stations operating under WiMAX standard.

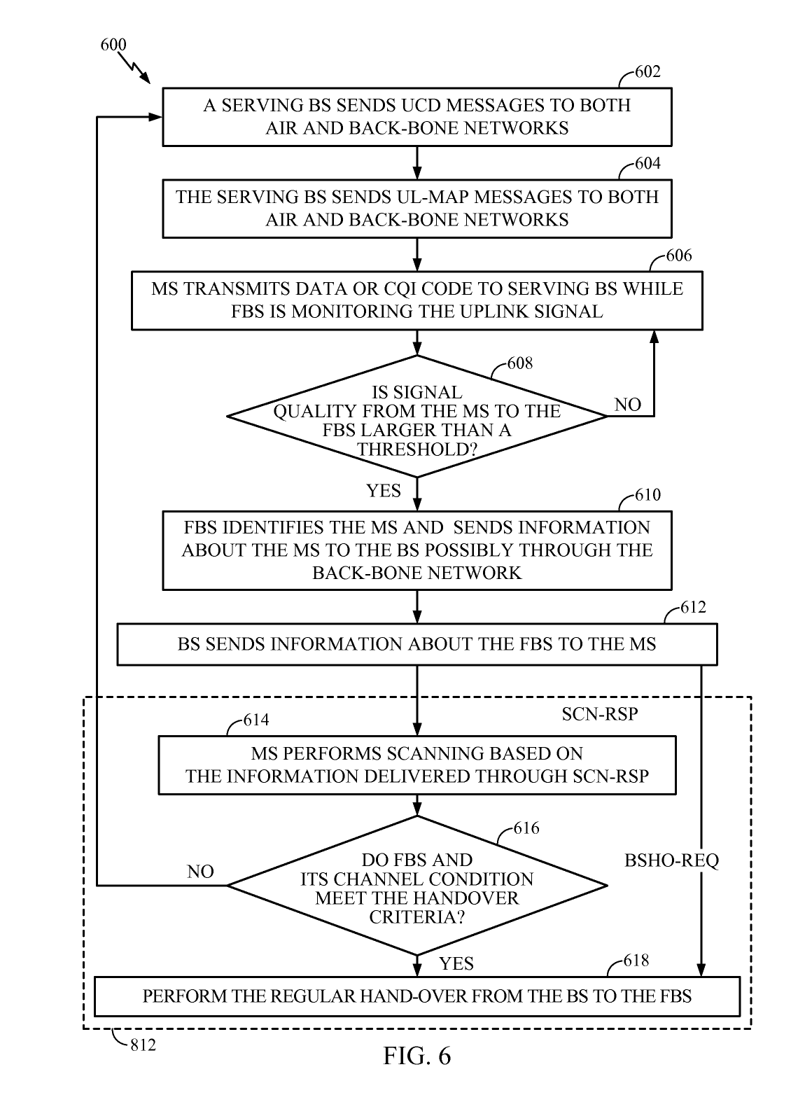

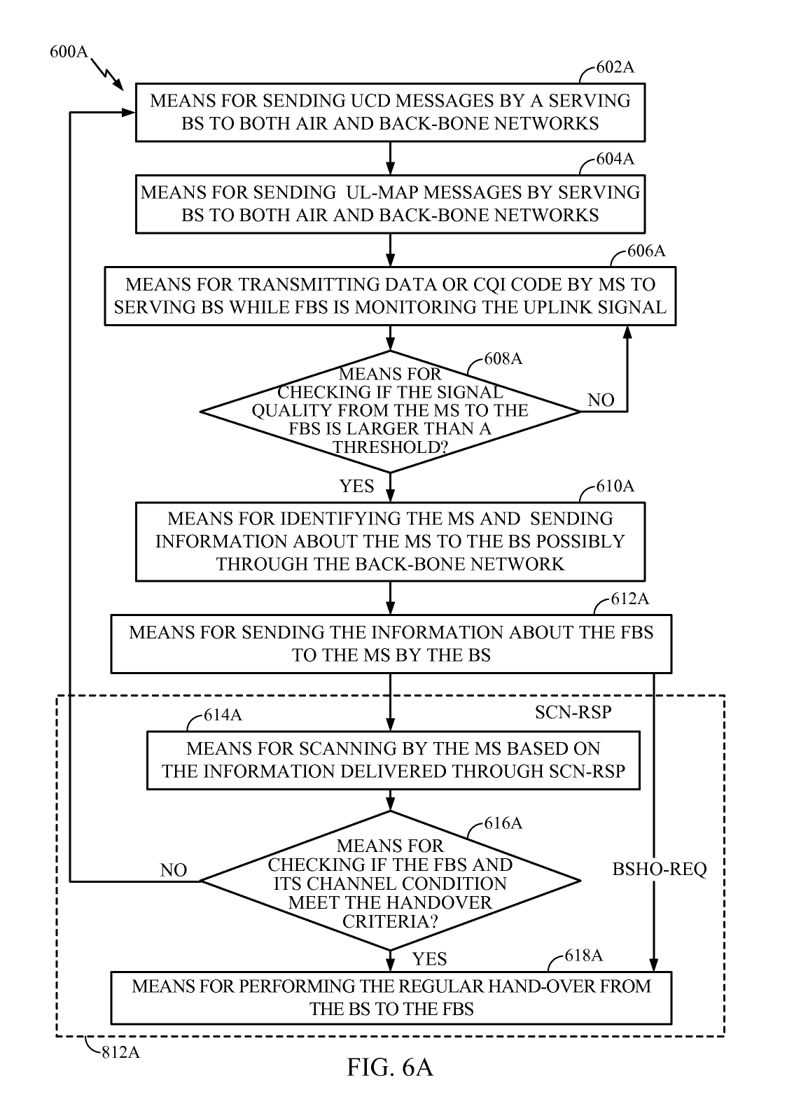

FIG. 6 illustrates example operations for an effective handover from a serving base station to an FBS according to the first example scenario. At 602, a serving BS sends UCD messages across both air and back-bone networks. Message formats may not necessarily be the same. By using the back-bone network, the FBS receives UCD messages from a plurality of base stations, each of which may use a different frequency. At 604, the serving BS sends UL-MAP messages across both air and back-bone networks. The format of these messages does not need to be the same.

At 606, the MS may transmit data or Channel Quality Information (CQI) code to the serving BS while the FBS is monitoring the uplink (UL) signal. At 608, the FBS detects UL signal, and measure the signal quality. If the signal quality or CINR (carrier to interference plus noise ratio) is better than a certain threshold, the MS is a good candidate for handover. For certain embodiments of the present disclosure, the threshold may be 15 dBs. At 610, the FBS may identify the MS using the UL-MAP message, and send a Femto Base Station Handover Request (FBSHO-REQ) message to the serving base station to request a handover. The FBSHO-REQ message may include information about the MS, such as basic CID or CQICH_ID, channel quality or information about the FBS. The FBSHO-REQ message may be sent through the back-bone network.

At 612, the serving BS sends a mobile scanning interval allocation response (MOB_SCN-RSP) message to the MS to initiate scanning. This message may include information about the FBS, such as frequency, preamble index, Radio frequency (RF) bandwidth and BS ID. For certain embodiments, the serving BS may send a Mobile Base Station Handover Request (MOB-BSHO-REQ) message to the MS instead of a Mobile Scanning Interval Allocation Response (MOB_SCN-RSP) message to initiate the handover quickly without any scanning procedure.

At 614, the MS starts scanning based on the information delivered through the MOB_SCN-RSP message. At 616, If the MS detects the FBS and determines that the channel conditions of the FBS meet the handover criteria, the MS may perform a regular handover procedure defined in the standard.

For certain embodiments of the present disclosure, an FBS may have two or more separate RF modules, one for its own wireless cellular network and the other for scanning the mobile stations that enter into its coverage. Each scanning module may be set, or preset, to the RF bandwidth and frequency of one or more of the neighboring base stations at the time of installation, thereby allowing the scanning modules to a plurality of frequency bands.

For certain embodiments of the present disclosure, when there are a plurality of base stations in the neighborhood, a scanning module may scan multiple base stations one after another in a time multiplexing manner.

For certain embodiments, all of the regular BSs may be assumed to have time- synchronized frame boundaries. The FBS may also have a time-synchronized frame boundary.

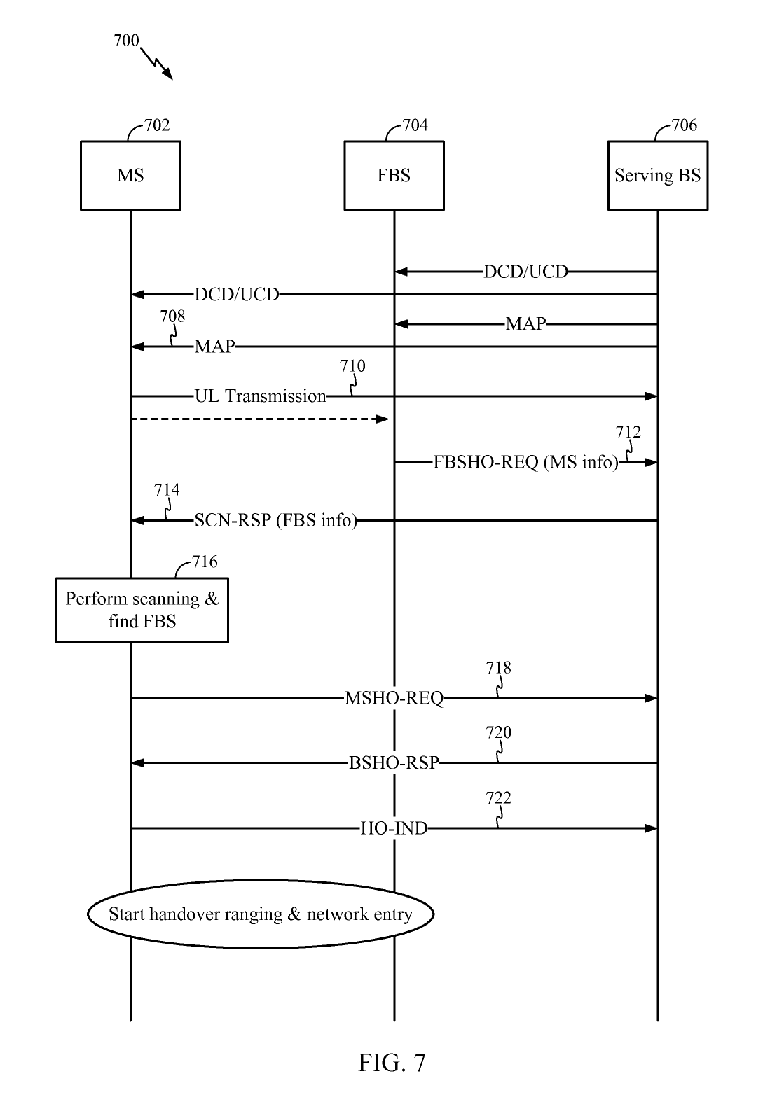

FIG. 7 illustrates the messages exchanged between an MS, a serving BS and an FBS during handover procedure, according to certain embodiments of the present disclosure. The serving BS 706 sends a UL-MAP 708 message to both an MS 702 and the FBS 704. The MS may transmit an uplink signal to the serving BS and in the meantime, the FBS may listen and detect the signal. If the signal quality and hence the channel between the MS 702 and the FBS 706 is better than a certain threshold, the FBS may send a FBSHO-REQ message 712 to the serving BS with information about the MS to request a handover.

The serving BS 706 sends a MOB_SCN-RSP message 714 to the MS with information about the FBS 704. At 716, the MS scans the neighboring Femto base stations and finds the FBS 704. The MS sends a MOB_MSHO-REQ message 718 to the serving BS 706 to request a handover. The serving BS sends a response BSHO-RSP message 720 to the MS 702 to confirm the handover. The MS sends a HO-IND message 722 to the serving BS 706 to indicate that it is going to handover to the FBS 704. Next, the MS and the FBS perform handover ranging and network entry procedures.

For certain embodiments of the present disclosure, an FBS may also be configured with further information about the neighboring BSs. The information may include wireless channel conditions between the BS and the FBS such as propagation delay, transmission power level that an MS close to the FBS may use and other information. The FBS may use this information to increase the performance of monitoring the signals of the mobile stations that are closer to the FBS.

For certain embodiments, an FBS may request ranging information about an MS from the serving BS through the back-bone network. The FBS may use the Basic CID of the MS by monitoring the DL-MAP (Downlink Access Definition) message from the serving BS. The ranging information may include propagation delay, transmission power and other information. This information may be used by the FBS to increase its monitoring performance.

For certain embodiments of the present disclosure, an FBS may periodically broadcast a MOB_NBR-ADV message that includes information about neighboring regular BSs so that an MS may handover from the FBS to a regular BS by following the regular scanning and handover procedures described in the standard.

Radio coverage of a regular BS may be much larger than that of an FBS. Therefore, if a mobile station transmits signals that are weak enough not to disturb the network of the regular BS and strong enough for the FBS to monitor, the FBS may easily detect the MS getting into its coverage. Therefore, the MS may not add much interference to the system.

In the second scenario of the present disclosure, an MS may broadcast a request for help (e.g., an ‘SOS’ or a Beacon message) when it faces weak channel conditions from the serving BS. If the FBS in the vicinity of the MS receives this signal, it may request for a handover.

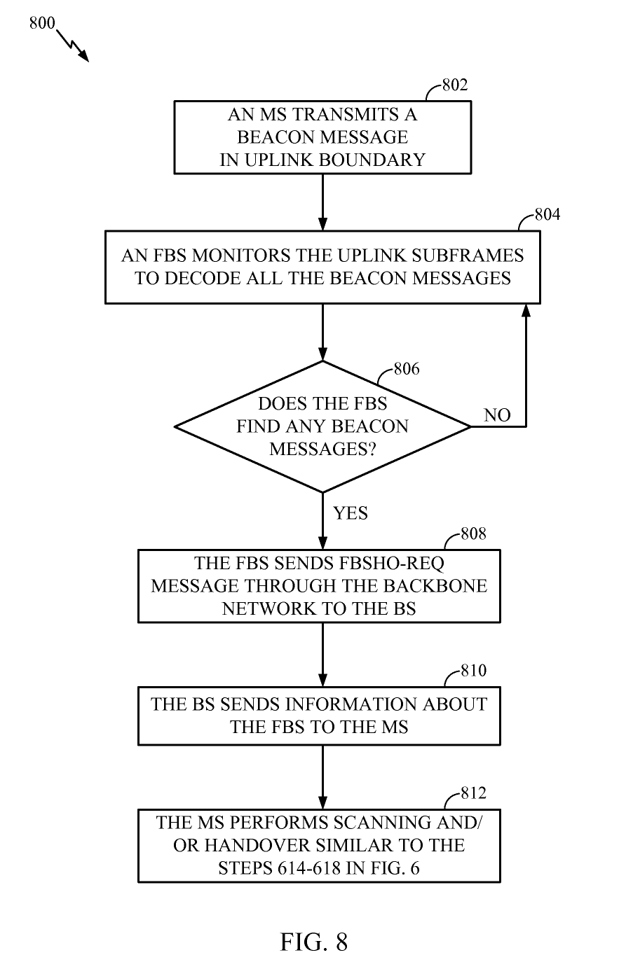

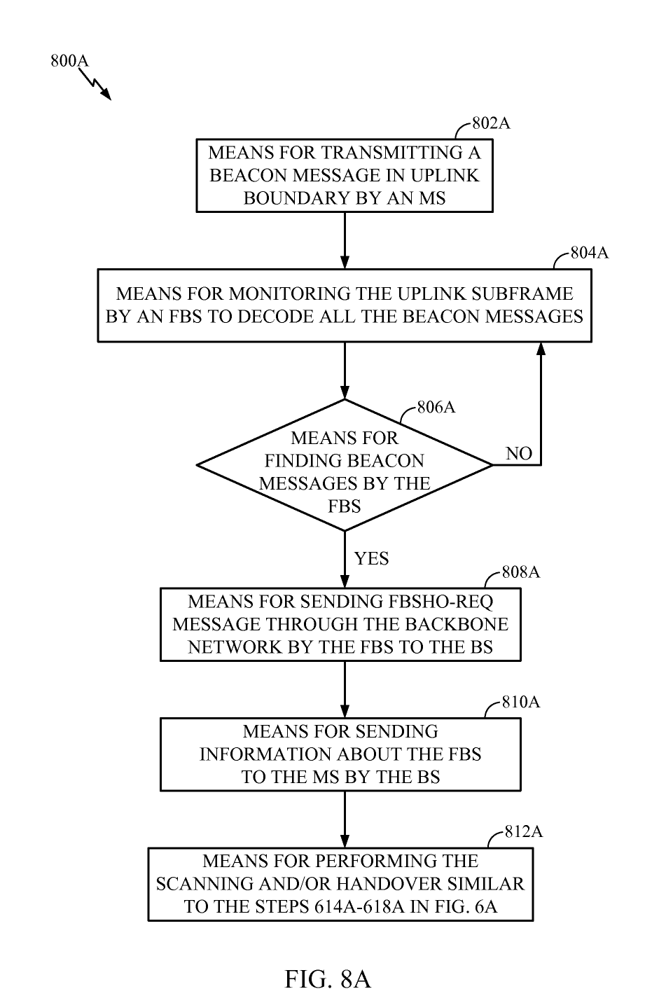

The example operations for performing handover utilizing the second handover scenario are illustrated in FIG. 8 in accordance with certain embodiments of the present disclosure. At 802, an MS may transmit a Beacon message in uplink boundary. The message may include basic CID of the MS, serving BS ID, channel quality of the serving BS and other information.

For certain embodiments of the present disclosure, in order to make sure the Beacon signal of an MS does not interfere with UL reception of a serving BS, the MS may start transmitting a Beacon message only when the channel quality of the serving BS goes down below a certain threshold. In certain embodiments, the Beacon signal may be much weaker than the uplink signal so that it does not add much interference in the main network.

At 806, the FBS monitors the whole UL sub-frame to decode all the Beacon messages. If the FBS finds a Beacon message, at 808, it sends an FBSHO-REQ message to the serving BS through the back-bone network to request a handover. At 810, the serving BS sends information about the FBS to the MS and notifies the MS of the possibility of a handover. At 812, the MS performs scanning and/or handover similar to 614-618 described in FIG. 6.

In the above scenario, the MS may be required to have a Beacon transmission feature, while such a feature may not be defined in the current standards, the Beacon transmission feature may not disturb the standard network. Thus, mobile stations with this feature may coexist with mobile stations that do not have this feature.

For certain embodiments of the present disclosure, if a plurality of mobile stations need to send Beacon messages simultaneously, they can select a TO (Transmission Opportunity) randomly. For certain embodiments, network configuration parameters may be as follows: RF bandwidth=10 MHz, number of UL sub-channels=35, number of OFDMA symbol in UL=15, number of slots in time axis in UL=5, and Beacon message size=50 bytes.

For such an embodiment, each TO message may comprise two sub-channels with 15 OFDMA symbols, which is equivalent to 10 slots that can carry 60 bytes of data modulated with QPSK. Therefore, 35/2=17 TO slots may be available in a frame. An MS may randomly choose a TO slot for transmitting a SOS message.

Thus, certain embodiments of the present disclosure may enable a smooth handover from a serving BS to an FBS and vice-versa without increasing the length of a MOB_NBR-ADV message that may be transmitted by the serving BS. As a result, there is no increase in the overhead of the system. The ideas presented in the current disclosure may be applicable to any mobile wireless network.

The various operations of methods described above may be performed by various hardware and/or software component(s) and/or module(s) corresponding to means-plus-function blocks illustrated in the Figures. For example, blocks 602-618 illustrated in FIG. 6 correspond to means-plus-function blocks 602A-618A illustrated in FIG. 6A. Also, blocks 802-812 illustrated in FIG. 8 correspond to means-plus-function blocks 802A-812A illustrated in FIG. 8A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a Femto base station (FBS), comprising:
monitoring signal quality of a mobile station;
transmitting a request for a handover from a serving base station to the Femto base station if the signal quality is higher than a threshold; and
initiating handover of the mobile station from the serving base station to the FBS.

2. The method of claim 1, wherein monitoring signal quality comprises:
monitoring communication between the mobile station and the serving base station and detecting an uplink signal or receiving a Beacon message from the mobile station.

3. The method of claim 2, wherein monitoring communication between the mobile station and the serving base station comprises monitoring a plurality of preset frequency bands in a time multiplexed manner.

4. The method of claim 1, wherein the request for the handover is transmitted through a back-bone network from the FBS to the serving base station.

5. A method for wireless communications by a mobile station (MS), comprising:
transmitting a signal to a serving base station (BS);
receiving, from the serving BS, information about a Femto BS that is a candidate for handover; and
performing scanning based on the information received about the FBS.

6. The method of claim 5, wherein transmitting a signal comprises:
transmitting a Beacon message to the Femto base station when the channel quality between the mobile station and the serving base station is smaller than a threshold.

7. The method of claim 6, wherein the mobile station selects a transmission opportunity for transmitting the Beacon message randomly.

8. A method for wireless communications by a serving Base Station (BS), comprising:
receiving a request for handover from a Femto base station (FBS);
transmitting a signal to a mobile station (MS) with information about the FBS; and
receiving a message from the MS to initiate the handover from the serving base station to the FBS.

9. The method of claim 8, further comprising sending channel description messages and MAP messages through a back-bone network.

10. The method of claim 8, wherein the request for handover from the FBS is received through a back-bone network.

11. An apparatus for wireless communications by a Femto base station (FBS), comprising:
logic for monitoring signal quality of a mobile station;
logic for transmitting a request for a handover from a serving base station to the Femto base station if the signal quality is higher than a threshold; and
logic for initiating handover of the mobile station from the serving base station to the FBS.

12. The apparatus of claim 11, wherein the logic for monitoring signal quality comprises:
logic for monitoring communication between the mobile station and the serving base station and detecting an uplink signal or receiving a Beacon message from the mobile station.

13. The apparatus of claim 12, wherein the logic for monitoring communication between the mobile station and the serving base station comprises logic for monitoring a plurality of preset frequency bands in a time multiplexed manner.

14. The apparatus of claim 11, wherein the request for the handover is transmitted through a back-bone network from the FBS to the serving base station.

15. An apparatus for wireless communications by a mobile station (MS), comprising:
logic for transmitting a signal to a serving base station (BS);
logic for receiving, from the serving BS, information about a Femto BS that is a candidate for handover; and
logic for performing scanning based on the information received about the FBS.

16. The apparatus of claim 15, wherein the logic for transmitting a signal comprises:
logic for transmitting a Beacon message to the Femto base station when the channel quality between the mobile station and the serving base station is smaller than a threshold.

17. The apparatus of claim 16, wherein the mobile station selects a transmission opportunity for transmitting the Beacon message randomly.

18. An apparatus for wireless communications by a serving Base Station (BS), comprising:
logic for receiving a request for handover from a Femto base station (FBS);
logic for transmitting a signal to a mobile station (MS) with information about the FBS; and
logic for receiving a message from the MS to initiate the handover from the serving base station to the FBS.

19. The apparatus of claim 18, further comprising logic for sending channel description messages and MAP messages through a back-bone network.

20. The apparatus of claim 18, wherein the request for handover from the FBS is received through a back-bone network.

21. An apparatus for wireless communications by a Femto base station (FBS), comprising:
means for monitoring signal quality of a mobile station;
means for transmitting a request for a handover from a serving base station to the Femto base station if the signal quality is higher than a threshold; and
means for initiating handover of the mobile station from the serving base station to the FBS.

22. The apparatus of claim 21, wherein the means for monitoring signal quality comprises:
means for monitoring communication between the mobile station and the serving base station and detecting an uplink signal or receiving a Beacon message from the mobile station.

23. The apparatus of claim 22, wherein the means for monitoring communication between the mobile station and the serving base station comprises means for monitoring a plurality of preset frequency bands in a time multiplexed manner.

24. The apparatus of claim 21, wherein the request for the handover is transmitted through a back-bone network from the FBS to the serving base station.

25. An apparatus for wireless communications by a mobile station (MS), comprising:
means for transmitting a signal to a serving base station (BS);
means for receiving, from the serving BS, information about a Femto BS that is a candidate for handover; and
means for performing scanning based on the information received about the FBS.

26. The apparatus of claim 25, wherein the means for transmitting a signal comprises:
means for transmitting a Beacon message to the Femto base station when the channel quality between the mobile station and the serving base station is smaller than a threshold.

27. The apparatus of claim 26, wherein the mobile station selects a transmission opportunity for transmitting the Beacon message randomly.

28. An apparatus for wireless communications by a serving Base Station (BS), comprising:
means for receiving a request for handover from a Femto base station (FBS);
means for transmitting a signal to a mobile station (MS) with information about the FBS; and
means for receiving a message from the MS to initiate the handover from the serving base station to the FBS.

29. The apparatus of claim 28, further comprising means for sending channel description messages and MAP messages through a back-bone network.

30. The apparatus of claim 28, wherein the request for handover from the FBS is received through a back-bone network.

31. A computer-program product for wireless communications by a Femto base station (FBS), comprising a computer readable medium having instructions stored thereon, the instructions being executable by one or more processors and the instructions comprising:
instructions for monitoring signal quality of a mobile station;
instructions for transmitting a request for a handover from a serving base station to the Femto base station if the signal quality is higher than a threshold; and
instructions for initiating handover of the mobile station from the serving base station to the FBS.

32. The computer-program product of claim 31, wherein the instructions for monitoring signal quality comprise:
instructions for monitoring communication between the mobile station and the serving base station and detecting an uplink signal or receiving a Beacon message from the mobile station.

33. The computer-program product of claim 32, wherein the instructions for monitoring communication between the mobile station and the serving base station comprise instructions for monitoring a plurality of preset frequency bands in a time multiplexed manner.

34. The computer-program product of claim 31, wherein the request for the handover is transmitted through a back-bone network from the FBS to the serving base station.

35. A computer-program product for wireless communications by a mobile station (MS), comprising a computer readable medium having instructions stored thereon, the instructions being executable by one or more processors and the instructions comprising:
instructions for transmitting a signal to a serving base station (BS);
instructions for receiving, from the serving BS, information about a Femto BS that is a candidate for handover; and
instructions for performing scanning based on the information received about the FBS.

36. The computer-program product of claim 35, wherein the instructions for transmitting a signal comprise:
instructions for transmitting a Beacon message to the Femto base station when the channel quality between the mobile station and the serving base station is smaller than a threshold.

37. The computer-program product of claim 36, wherein the mobile station selects a transmission opportunity for transmitting the Beacon message randomly.

38. A computer-program product for wireless communications by a serving Base Station (BS), comprising a computer readable medium having instructions stored thereon, the instructions being executable by one or more processors and the instructions comprising:
instructions for receiving a request for handover from a Femto base station (FBS);
instructions for transmitting a signal to a mobile station (MS) with information about the FBS; and
instructions for receiving a message from the MS to initiate the handover from the serving base station to the FBS.

39. The computer-program product of claim 38, wherein the instructions further comprise instructions for sending channel description messages and MAP messages through a back-bone network.

40. The computer-program product of claim 38, wherein the request for handover from the FBS is received through a back-bone network.
